(19) United States
(12) Patent Application Publication
(10) Pub. No.: US 2008/0120820 A1
(43) Pub. Date: May 29, 2008

(54) Method for making expandable slats for blinds

(76) Inventors: Wen Ying Liang, Fuxing Shiang (TW); Sheng Ying Hsu, Fuxing Shiang (TW); Wu Chung Nien, Fuxing Shiang (TW); Chien Chih Huang, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/604,815

(22) Filed: Nov. 28, 2006

(51) Int. Cl. B23P 19/04

(52) U.S. Cl. 29/24.5

(57) ABSTRACT

A method for making expandable slats for blinds includes a step of flatting strip, a step of folding two longitudinal sides of the strip inward and the two longitudinal sides being in contact with each other at a central axis of the strip, a step of pressing the longitudinal sides on the strip, a step of adding adhesive along the two longitudinal sides so as to form two respective adhesive portions, a step of wrapping the strip on a polygonal frame with the adhesive portions facing outward so as to form multiple laminated sections on multiple sides of the polygonal frame, and a step of cutting the laminated sections into sub-sections.

### FIELD OF THE INVENTION

The present invention relates to a method for making expandable slots for blinds.

### BACKGROUND OF THE INVENTION

A conventional blind includes a plurality of parallel slats which are connected by tilt cords and lift cords so that when the user operates the tilt cords or the lift cords, the slats are arranged as designed. However, the conventional slats are made as flat strips which can only block the sunshine but cannot keep the cold outside temperature from entering the interior of rooms. Some blinds manufacturers develop expandable slats which can be expanded as hollow tubular members so as to maintain air in the hollow tubular members. The air in the hollow tubular members forms a thick air curtain to prevent loss of temperature. A conventional method for making the hollow tubular members first folds a strip along a central axis to form an upper and lower adhered sides. Adhesive is then spread on the adhesive sides to connect the adhesive sides and the folded strip is then wrapped on a mandrel. However, due to the arrangements of the mechanical parts of the machine for making the hollow tubular, the upper adhesive side often cannot be attached to the lower adhesive side perfectly. Therefore, when the expandable tubular members are pulled, the shape that the expanded hollow tubular members is not satisfied by the users.

The present invention intends to provide a method for making expandable slats of blinds and the adhesive line is located at a center of the slat so that when the slats are expanded, the adhesive line is pulled in vertical direction so as to ensure the shape of the expandable slats is as desired.

### SUMMARY OF THE INVENTION

The present invention relates to a method for making expandable slats for blinds, and the method comprises a step of flatting strip to make the strip have have flat upper and bottom surfaces by a first roller set; a step of folding two longitudinal sides of the strip inward by a second roller set and the two longitudinal sides being in contact with each other at a central axis of the strip; a step of pressing the longitudinal sides on the strip by a third roller set; a step of adding adhesive along the two longitudinal sides and the adhesive being on both of the two longitudinal sides so as to form two respective adhesive portions; a step of wrapping strip on a polygonal frame with the adhesive portions facing outward so as to form multiple laminated sections on multiple sides of the polygonal frame, and a step of cutting the laminated sections into sub-sections.

The primary object of the present invention is to provide a method for efficiently making expandable slats for blinds and the two longitudinal sides are adhered with each other and the adhered sides are located at a central axis of the strip.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the arrangement of the mechanical parts of the method of the present invention;

FIG. 2 is a side view of the arrangement in FIG. 1;

FIG. 3 shows the status of the strip in each step of the method of the present invention;

FIG. 4 shows the sub-sections and the expanded status of the sub-section;

FIG. 5 shows the slats made by the method of the present invention of a blind;

FIG. 6 shows another type of slats made by the method of the present invention, and

FIG. 7 shows that the sub-section is cut in two halves and each half is expanded.

### DETAILED DESCRIPTION OF THE PREFERRED EMBODIMENT

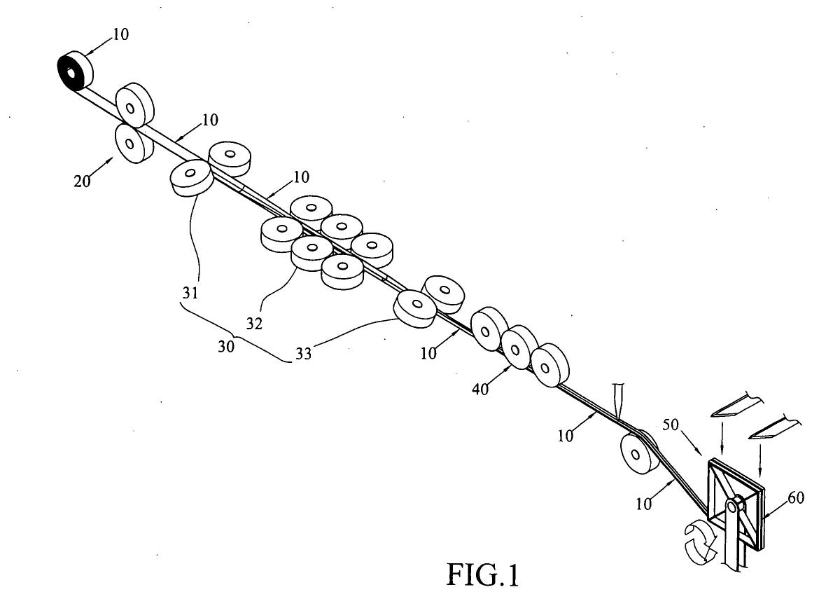

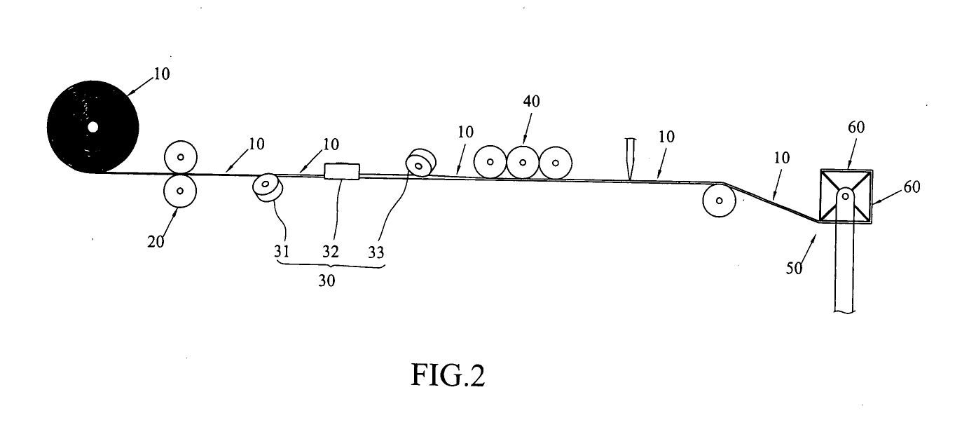

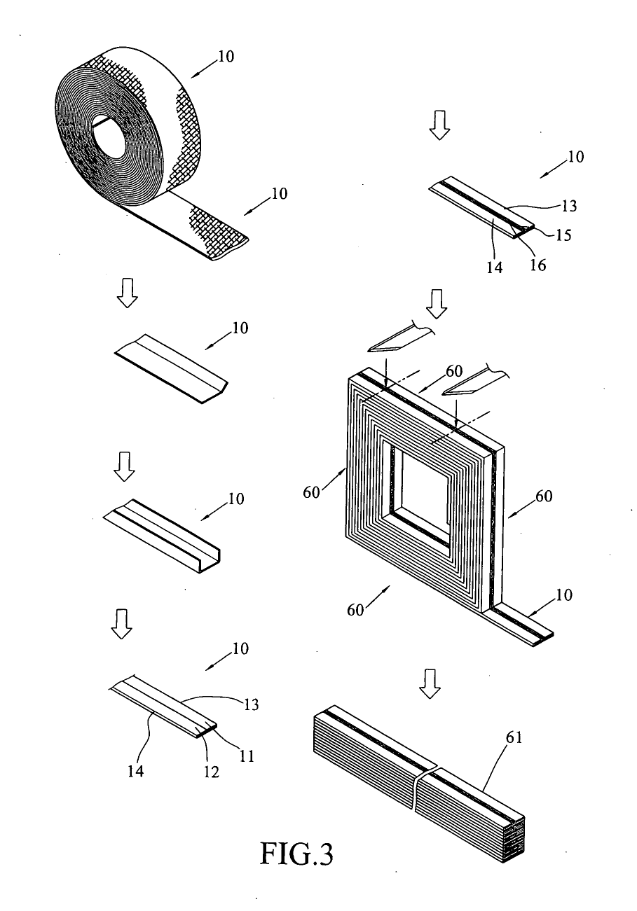

Referring to FIGS. 1 to 4, the method for making expandable slats for blind of the present invention comprises the following steps:

a step of flatting strip 10: rolling the strip 10 by a first roller set 20 to make the strip 10 have flat upper and bottom surfaces. Multiple pairs of rollers of the first roller set 20 can be set in the first roller set 20 according practical needs.

a step of folding: folding two longitudinal sides of the strip 10 inward by a second roller set 30 and the two longitudinal sides 11, 12 being in contact with each other at a central axis of the strip 10. The second roller set 30 includes a first unit 31, a second unit 32 and a third unit 33. The first and third units 31, 33 each include two rollers and the strip 10 extends between the two rollers. The two rollers of each of the first and third units 31, 33 are located at an angle relative to a horizontal plane so that the first unit 31 folds the two longitudinal sides of the strip 10 upward and the third unit 31 folds the two longitudinal sides of the strip 10 downward toward the central axis of the strip 10.

a step of pressing: pressing the longitudinal sides 11, 23 on the strip 10 by a third roller set 40;

a step of gluing: adding adhesive along the two longitudinal sides 11, 12 and the adhesive being on both of the two longitudinal sides 11, 12 so as to form two respective adhesive portions 15, 16.

a step of wrapping: wrapping the strip 10 on a polygonal frame 50 and the adhesive portions 15, 16 facing outward so that each of multiple sides of the polygonal frame 50 has a laminated section 60. The adhesive portions 15, 16 adhere the bottom surface of the strip 10 laminated on the adhesive portions 15, 16 so that the outer layer of each of the laminated sections 60 is glued to the lower layer by the adhesive portions 15, 16.

a step of cutting: cutting the laminated sections 60 into sub-sections 61.

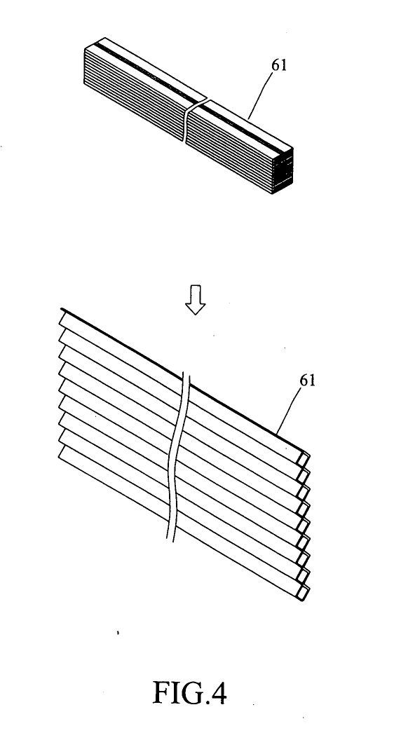

When the laminated section 60 is pulled in two opposite directions as shown in FIG. 4, each layer of the laminated section 60 is expanded to be a hollow tubular member as shown. The adhesive portions 15, 16 are located at a center of each expandable slat.

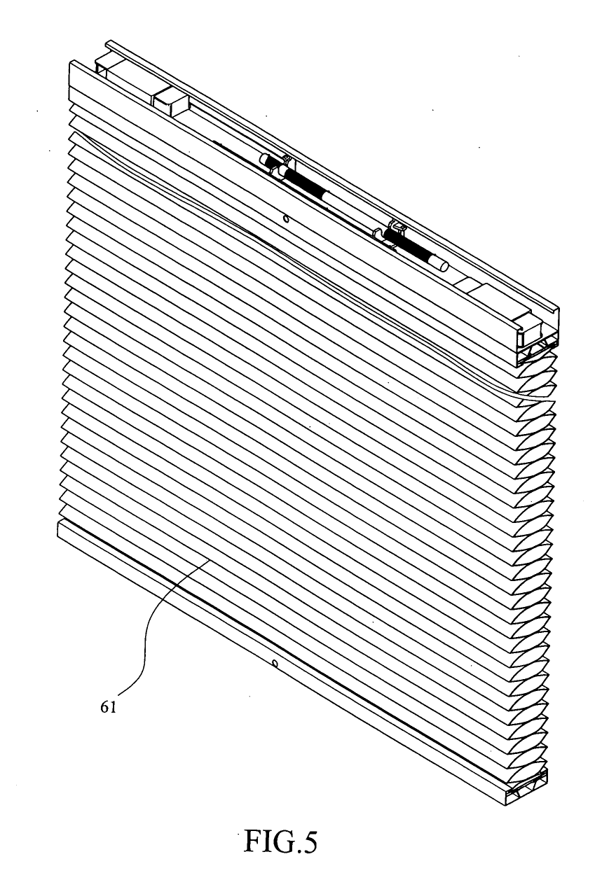

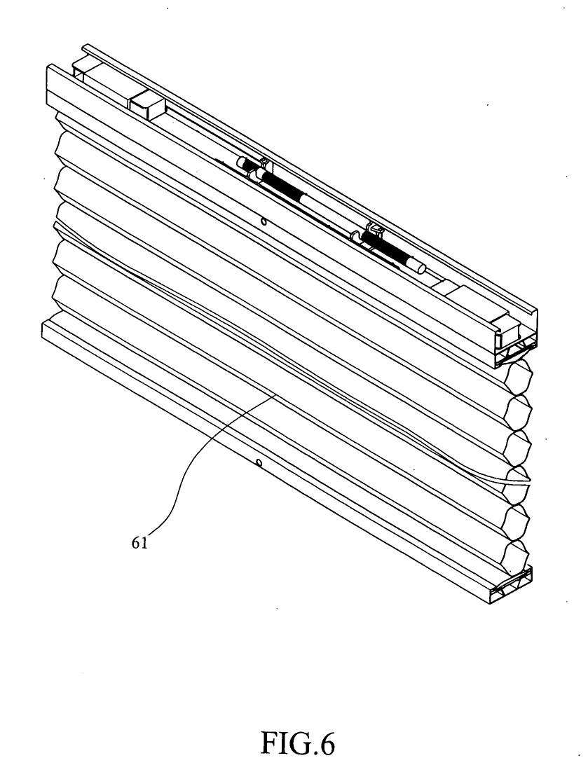

FIG. 5 shows that the expandable slats are expanded slightly and FIG. 6 shows that the expandable slats are expanded fully.

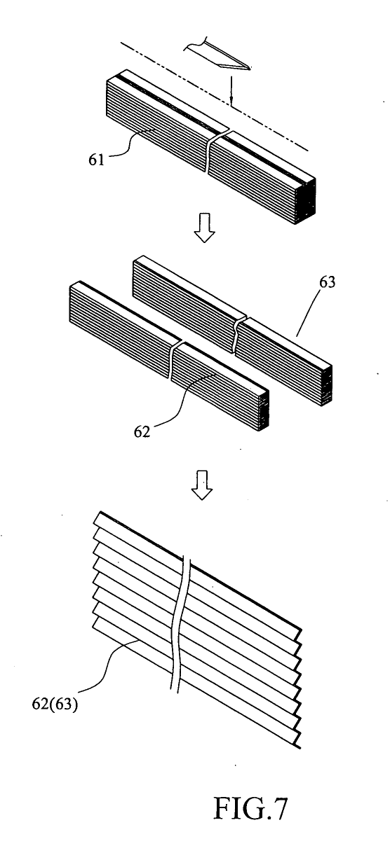

FIG. 7 shows that a step of secondary cutting can be taken and which cuts the sub-sections 61 along a central axis thereof so as to form two halves 62, 63. Each half 62/63 forms a continuous single layer slat.

While we have shown and described the embodiment in accordance with the present invention, it should be clear to those skilled in the art that further embodiments may be made without departing from the scope of the present invention.

What is claimed is:

1. A method for making expandable slats for blinds, comprising:
a step of flatting strip: rolling the strip by a first roller set to make the strip have flat upper and bottom surfaces;
a step of folding: folding two longitudinal sides of the strip inward by a second roller set and the two longitudinal sides being in contact with each other at a central axis of the strip;
a step of pressing: pressing the longitudinal sides on the strip by a third roller set;
a step of gluing: adding adhesive along the two longitudinal sides and the adhesive being on both of the two longitudinal sides so as to form two respective adhesive portions;
a step of wrapping: wrapping the strip on a polygonal frame and the adhesive portions facing outward so as to form multiple laminated sections on multiple sides of the polygonal frame, and
a step of cutting: cutting the laminated sections into sub-sections.

2. The method as claimed in claim 1, wherein the second roller set includes a first unit, a second unit and a third unit, the first and third units each include two rollers and the strip extends between the two rollers, the two rollers of each of the first and third units are located at an angle relative to a horizontal plane.

3. The method as claimed in claim 1, wherein the first and third units of the second roller set each includes two rollers.

4. The method as claimed in claim 1, wherein the adhesive portions adhere the bottom surface of the strip laminated on the adhesive portions in the step of wrapping.

5. The method as claimed in claim 1 further comprising a step of secondary cutting which cuts the sub-sections along a central axis thereof so as to form two halves.
